(19) United States
(12) Patent Application Publication
(10) Pub. No.: US 2024/0149610 A1
(43) Pub. Date: May 9, 2024

(54) FULL FACE FABRICATED VEHICLE WHEEL AND METHOD FOR PRODUCING SUCH A FULL FACE FABRICATED VEHICLE WHEEL

(71) Applicant: Maxion Wheels Holding GmbH, Konigswinter (DE)

(72) Inventors: Renato de Jesus Madeira, Vinhedo (BR); Marcio Aparecido Oliveira, Limeira (BR); Nicholas Spagnol, Limeira (BR)

(73) Assignee: Maxion Wheels Holding GmbH, Konigswinter (DE)

(21) Appl. No.: 17/979,887

(22) Filed: Nov. 3, 2022

(51) Int. Cl. B60B 3/02; B60B 3/06

(52) U.S. Cl. CPC B60B 3/02; B60B 3/06

(57) ABSTRACT

A full face fabricated euroflange or non-euroflange vehicle wheel including a rim and a disc. The rim defines a central axis of the wheel and includes an inboard retaining flange, an inboard tire bead seat, an outboard tire bead seat, and a well located between the inboard and outboard tire bead seats. The rim further includes an outboard flange, wherein the outboard flange is outwardly turned and extends in a radially outwardly direction away from the central axis. The disc has a central hub mounting portion including a hub hole located about the central axis and a plurality of lug bolt receiving holes circumferentially spaced about the hub hole. A mounting area is formed at an outer end of the disc. The mounting area defines a region of reduced thickness at the outer end relative to a thickness of the disc directly adjacent to the outer end, wherein the outboard flange of the rim is configured to be disposed within the mounting area of the disc and secured thereto.

### BACKGROUND OF THE INVENTION

This invention relates in general to vehicle wheels and in particular to an improved full face fabricated euroflange or non-euroflange type of vehicle wheel and method for producing such a full face fabricated euroflange or non-euroflange type of vehicle wheel.

A conventional fabricated vehicle wheel is typically of a two-piece construction and includes an inner disc and an outer “full” rim. The disc can be cast, forged, or fabricated from steel, aluminum, or other alloys, and includes an inner annular wheel mounting portion and an outer annular portion. The wheel mounting portion defines an inboard mounting surface and includes a center pilot or hub hole, and a plurality of lug receiving holes formed therethrough for mounting the wheel to an axle of the vehicle. The rim is fabricated from steel, aluminum, or other alloys, and includes an inboard tire bead seat retaining flange, an inboard tire bead seat, an axially extending well, an outboard tire bead seat, and an outboard tire bead seat retaining flange. In some instances, a three-piece wheel construction having a mounting cup secured to the disc is used. In both types of constructions, the outer annular portion of the disc is typically secured to the rim by welding.

A conventional full face fabricated vehicle wheel is distinguished from other types of fabricated wheels by having a one-piece wheel disc construction. In particular, the full face wheel includes a “full face” disc and a “partial” rim. The full face disc can be formed cast, forged, or fabricated from steel, aluminum, or other alloys. The full face disc includes an inner annular wheel mounting portion and an outer annular portion which defines at least a portion of an outboard tire bead seat retaining flange of the wheel. The wheel mounting portion defines an inboard mounting surface and includes a center pilot or hub hole, and a plurality of lug receiving holes formed therethrough for mounting the wheel to an axle of the vehicle. The partial rim is fabricated from steel, aluminum, or other alloys, and includes an inboard tire bead seat retaining flange, an inboard tire bead seat, an axially extending well, and an outboard tire bead seat. In some instances, the outboard tire bead seat of the rim and the outer annular portion of the disc cooperate to form the outboard tire bead seat retaining flange of the full face wheel. In both types of constructions, the outboard tire bead seat of the rim is positioned adjacent the outer annular portion of the disc and a weld is applied to secure the rim and the disc together.

A typical euroflange type of vehicle wheel may be formed as a one piece cast wheel or may be formed as a two piece full face fabricated euroflange vehicle wheel having a cast full face wheel disc and a partial wheel rim, such as shown in U.S. Pat. No. 5,564,792 to Archibald. In both types of constructions, the wheel does not include an outboard tire bead seat retaining flange having a generally axially outwardly extending lip or portion capable of receiving a conventional wheel balance weight.

### SUMMARY OF THE INVENTION

The present invention relates to an improved full face fabricated type of vehicle wheel and method for producing such a full face fabricated type of vehicle wheel as illustrated and/or described herein, wherein the full face fabricated vehicle wheel is one of a euroflange vehicle wheel or a non-euroflange vehicle wheel.

According to one embodiment, the vehicle wheel may comprise, individually and/or in combination, one or more of the following features, elements, or advantages: a full face fabricated vehicle wheel comprising: a rim defining a central axis of the wheel, wherein the rim includes: an inboard retaining flange; an inboard tire bead seat; an outboard tire bead seat; a well located between the inboard and outboard tire bead seats; an outboard flange, wherein the outboard flange is outwardly turned and extends in a radially outwardly direction away from the central axis; and a disc having: a central hub mounting portion including a hub hole located about the central axis and a plurality of lug bolt receiving holes circumferentially spaced about the hub hole; and a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto, wherein the full face fabricated vehicle wheel is one of a euroflange vehicle wheel or a non-euroflange vehicle wheel.

According to this embodiment, the rim is secured to the disc by one of welding, adhesives, and mechanical fasteners.

According to this embodiment, the outer end of the disc defines an inner surface, an outer surface, and an outermost tip, and wherein the outboard flange of the rim is configured to be secured onto the inner surface.

According to this embodiment, the outboard flange of the rim defines an inner surface, an outer surface, and an outermost tip, and wherein the outer surface of the outboard flange engages with and is secured onto the inner surface of the outer end of the disc.

According to this embodiment, the outboard flange of the rim is secured to the mounting area of the disc by a first weld located at the outermost tip of the outboard flange of the rim, and wherein the first weld is a generally continuous circumferential bead extending along the outermost tip of the outboard flange.

According to this embodiment, the rim is further secured to the disc by a second weld located over the first weld completely covering the outermost tip of the outboard flange.

According to this embodiment, the second weld and the outer end of the disc are machined to remove material from the second weld and the outer end of the disc to provide a smooth curved circumferential edge of the wheel.

According to this embodiment, the wheel further includes a securement securing the outboard flange of the rim to the mounting area of the disc, wherein a material is added and located over the securement, and wherein the outer end of the disc is machined to remove portions of the added material and the outer end of the disc to provide a smooth curved circumferential edge of the wheel.

According to this embodiment, the wheel further includes a single weld that secures the outboard flange of the rim to the mounting area of the disc, and wherein the single weld provides enough material such that the outer end of the disc and the single weld may be machined to provide a smooth curved circumferential edge of the wheel.

According to another embodiment, the vehicle wheel may comprise, individually and/or in combination, one or more of the following features, elements, or advantages: a full face fabricated vehicle wheel comprising: a rim having an outwardly turned outboard flange extending generally radially outwardly and extending in a direction away from a central axis of the vehicle wheel; and a disc having a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto, wherein the full face fabricated vehicle wheel is one of a euroflange vehicle wheel or a non-euroflange vehicle wheel.

According to this embodiment, the rim is secured to the disc by one of welding, adhesives, and mechanical fasteners.

According to this embodiment, the outer end of the disc defines an inner surface, an outer surface, and an outermost tip, and wherein the outboard flange of the rim is configured to be secured onto the inner surface.

According to this embodiment, the outboard flange of the rim defines an inner surface, an outer surface, and an outermost tip, and wherein the outer surface of the outboard flange engages with and is secured onto the inner surface of the outer end of the disc.

According to this embodiment, the outboard flange of the rim is secured to the mounting area of the disc by a first weld located at the outermost tip of the outboard flange of the rim, and wherein the first weld is a generally continuous circumferential bead extending along the outermost tip of the outboard flange.

According to this embodiment, the rim is further secured to the disc by a second weld located over the first weld completely covering the outermost tip of the outboard flange.

According to this embodiment, the second weld and the outer end of the disc are machined to remove material from the second weld and the outer end of the disc to provide a smooth curved circumferential edge of the wheel.

According to another embodiment, the vehicle wheel may comprise, individually and/or in combination, one or more of the following features, elements, or advantages: a vehicle wheel comprising: a rim defining an axis and having an outboard flange: and a disc having a recess formed therein at an outer end such that the recess defines a region of reduced thickness at the outer end, wherein the outboard flange of the rim is at least partially disposed within the recess of the disc, and wherein the rim is configured to be secured to the disc; wherein the full face fabricated vehicle wheel is one of a euroflange vehicle wheel or a non-euroflange vehicle wheel.

According to this embodiment, the recess is formed in the disc by a machining process to remove material of the outer end of the disc.

According to this embodiment, the recess is formed in the disc by one of a stamping and rolling process.

According to this embodiment, the rim is secured to the disc by one of welding, adhesives, and mechanical fasteners.

According to this embodiment, the rim is secured to the disc by a weld located at an outermost tip of the outboard flange.

According to this embodiment, the weld is a generally continuous circumferential bead extending along the outermost tip of the outboard flange.

According to another embodiment, a method for producing a vehicle wheel may comprise, individually and/or in combination, one or more of the following features, elements, or advantages: a method for producing a full face fabricated euroflange vehicle wheel comprising the steps of: providing a rim defining a central axis of the wheel, wherein the rim includes: an inboard retaining flange; an inboard tire bead seat; an outboard tire bead seat; a well located between the inboard and outboard tire bead seats; an outboard flange, wherein the outboard flange is outwardly turned and extends in a radially outwardly direction away from the central axis; providing a disc having: a central hub mounting portion including a hub hole located about the central axis and a plurality of lug bolt receiving holes circumferentially spaced about the hub hole; and a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto; and securing the disc to the rim; wherein the full face fabricated vehicle wheel is one of a euroflange vehicle wheel or a non-euroflange vehicle wheel.

According to this embodiment, the disc is secured to the rim by at least one weld.

According to this embodiment, disc is secured to the rim by a first weld and then by a second weld located over the first weld completely covering an outermost tip of the outboard flange.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a front perspective view of a first embodiment of a full face fabricated euroflange type of vehicle wheel in accordance with the present invention.

FIG. 2 is a cross-sectional view of the wheel taken along lines 2-2 in FIG. 1.

FIG. 3 is an enlarged cross-sectional view of an outboard mounting portion of the wheel of FIG. 1, as indicated in FIG. 2.

FIG. 4 is an enlarged cross-sectional view of an outer end of the disc of the wheel of FIG. 1 prior to attachment of the rim.

FIG. 5 is an enlarged cross-sectional view of the outboard mounting portion of the wheel of FIG. 1 illustrating an initial mounting step of positioning an outboard flange side of the rim adjacent a mounting area of the disc.

FIG. 6 is an enlarged cross-sectional view of the outboard mounting portion of the wheel of FIG. 1 illustrating an attachment step of welding a first weld to the rim and the disc.

FIG. 7 is an enlarged cross-sectional view of the outboard mounting portion of the wheel of FIG. 1 illustrating a further attachment step of welding a second weld to the rim and the disc.

FIG. 8 is an enlarged partial cross-sectional view of a second embodiment of a mounting portion of a full face fabricated euroflange vehicle wheel in accordance with the present invention.

FIG. 9 is an enlarged cross-sectional view of a recess formed in an outer end of the disc of the wheel of FIG. 8 prior to attachment of the rim.

FIG. 10 is an enlarged cross-sectional view of the outboard mounting portion of the wheel of FIG. 8 illustrating an initial mounting step of positioning an outboard flange side of the rim into the recess of the disc.

FIG. 11 is an enlarged cross-sectional view of the outboard mounting portion of the wheel of FIG. 8 illustrating an attachment step of welding the rim to the disc.

FIG. 12 is an enlarged cross-sectional view of a third embodiment of a mounting portion of a full face fabricated euroflange wheel in accordance with the present invention.

FIG. 13 is an enlarged cross-sectional view of a fourth embodiment of a mounting portion of a full face fabricated euroflange vehicle wheel in accordance with the present invention.

FIG. 14 is an enlarged cross-sectional view of the mounting portion of the mounting portion of FIG. 13 illustrating an attachment step of welding a rim to a disc.

FIG. 15 is an enlarged cross-sectional view of a fifth embodiment of a mounting portion of a full face fabricated non-euroflange vehicle wheel in accordance with the present invention.

FIG. 16 is an enlarged cross-sectional view of a sixth embodiment of a mounting portion of a full face fabricated non-euroflange vehicle wheel in accordance with the present invention.

### DETAILED DESCRIPTION OF THE PREFERRED EMBODIMENT

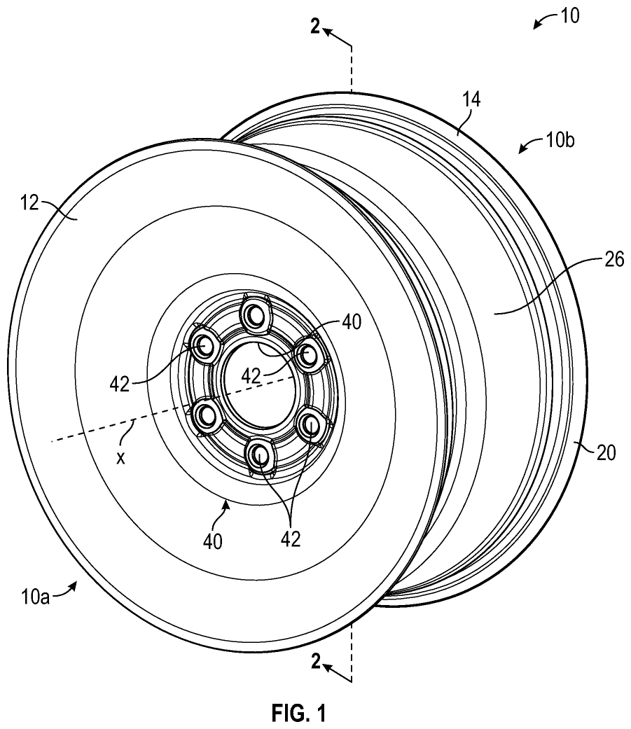

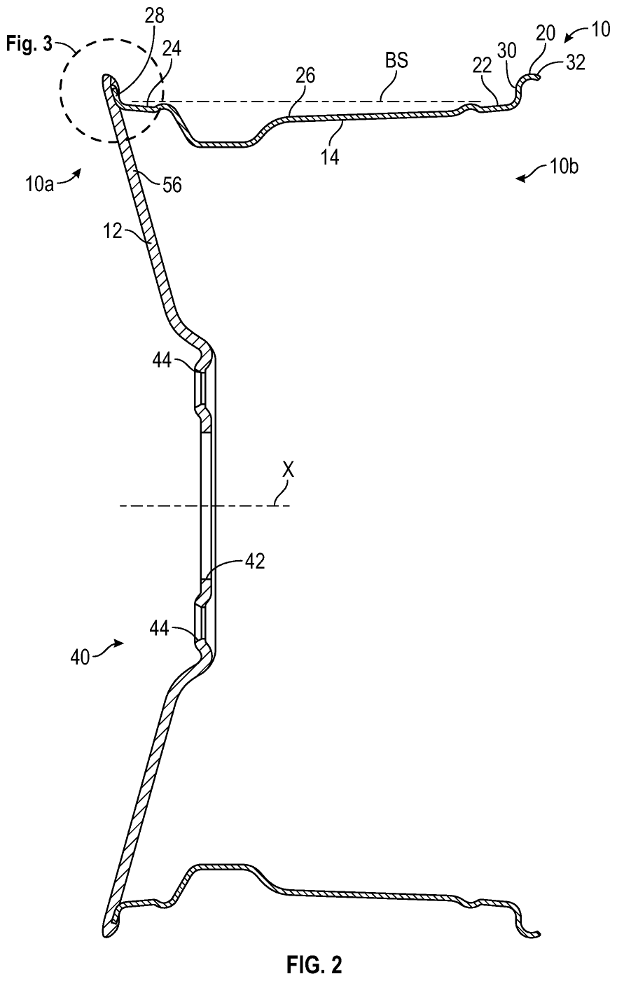

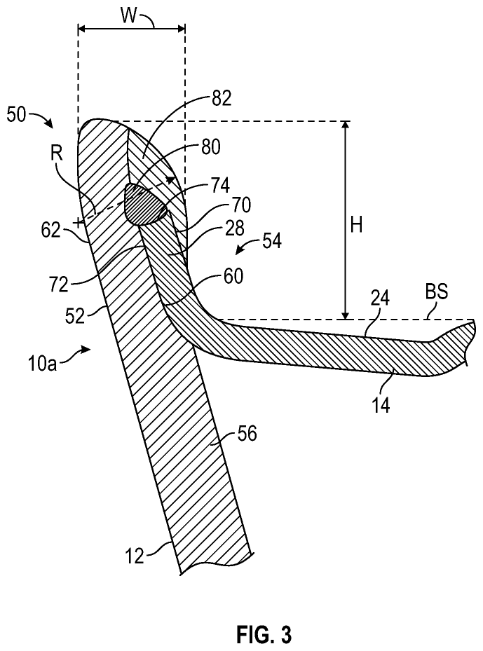

Referring now to the drawings, there is illustrated in FIGS. 1 and 2 a first embodiment of a full face fabricated euroflange type of vehicle wheel, indicated generally at 10. The vehicle wheel 10 can be of any suitable type of material or materials, such as for example, steel, aluminum, and alloys thereof and, in accordance with the present invention as will be discussed below, is operative to produce a “euroflange” type of vehicle wheel, an enlarged portion of which is shown in FIG. 3. As used herein, the term full face fabricated euroflange type of vehicle wheel means that the associated vehicle wheel does not include an outboard tire bead seat retaining flange having a generally axially outwardly extending lip or portion capable of receiving a conventional wheel balance weight and that the disc portion of the wheel forms the “visible” outboard face of the wheel, i.e., the rim portion does not form any portion of the “visible” outboard face of the wheel. Although the wheel 10 is illustrated and described in conjunction with the particular euroflange type of full face fabricated vehicle wheel constructions disclosed herein, it will be appreciated that the invention can be used in conjunction with other kinds of full face fabricated euroflange and full face fabricated non-euroflange vehicle wheel constructions. One advantage of the present invention is that a full face fabricated euroflange or non-euroflange type of vehicle wheel may be manufactured without having to use a casting method to produce a cast full face wheel disc of the associated known euroflange or non-euroflange

vehicle wheel.

The vehicle wheel 10 generally incudes a wheel disc, indicated generally at 12, and an annular wheel rim, indicated generally at 14. The wheel 10 can be generally described as having an outboard side, indicated generally at 10a, on the left-hand side as viewing FIGS. 1 and 2. The wheel 10 has an inboard side, indicated generally at 10b, on the right-hand side as viewing FIGS. 1 and 2. When mounted on the vehicle, the disc 12 is on the outboard side 10a.

In a preferred embodiment (and as illustrated herein), the disc 12 and the rim 14 are produced separately and then secured or joined together by any suitable means to produce the fabricated wheel 10. Suitable examples of securement include welding, adhesives, and mechanical fastening such as with the use of rivets, bolts, and screws. In a preferred embodiment, the disc 12 and the rim 14 are made from the same material, such as steel, and are then welded together to form the wheel 10. Of course, the wheel disc 12 and/or the wheel rim 14 may be made of any suitable materials, either of the same material or different materials, such as for example, aluminum, magnesium, titanium or alloys thereof, carbon fiber and/or composite materials and/or may be secured together by other suitable means, if so desired.

The combination of the annularly shaped disc 12 and the rim 14 defines a wheel axis X for the wheel 10. It should be understood that the details of the drawings in the Figures are not necessarily to scale and may have exaggerated dimensions to assist in clarity and understanding of the drawings. The rim 14 can have any suitable annular shape for receiving and supporting a tire (not shown). The rim 14 preferably has a continuous annular shape relative to the wheel axis X for accommodating a vehicle tire (not shown) mounted thereon.

Referring to FIG. 2, the rim 14 generally includes an inboard retaining flange 20, an inboard tire bead seat 22, an outboard tire bead seat 24, a tire well 26, and an outboard flange 28. The inboard tire bead seat 22 is adjacent to and connected with the inboard retaining flange 20. The inboard and outboard tire bead seats 22 and 24 provide mounting and contacting surfaces for sealing with a tire (not shown) mounted on the wheel 10. A broken line, indicated generally by BS, schematically represents the bead seat diameter or inner diameter portion of a tire that is mounted on the wheel 10. The conventionally known “rim width” may be determined as the axial distance between the tire bead seats 22 and 24. The wheel diameter is generally the radial diameter of the respective bead seats. It should be appreciated that the rim 14 can have any desired diameter and/or shape. The wheel 10 can be manufactured to any suitable size for mounting a tire thereon.

The tire well 26 generally defines the cavity or open region between the bead seats 22 and 24. The tire well 26 may be defined as the open region generally radially inwardly from the bead seat diameter BS.

The inboard retaining flange 20 generally provides for lateral or axial support of the tire mounted on the wheel 10. The inboard retaining flange 20 may include a sidewall 30 and a curled lip portion 32. The outboard flange 28 generally provides the same function as the inboard retaining flange 20 to provide for lateral or axial support of the tire mounted on the wheel 10. However, the structure of the outboard flange 28 along with its attachment to the disc 12 are very different in structure, as will be discussed below.

The disc 12 can be of any suitable construction. For example, the disc 12 may be produced from a single steel blank (not shown) which is then formed by suitable means to form the disc 12. The blank may be first provided as a smooth, flat annular or ring-shaped steel disc blank, and then preferably shaped such as by a flow forming process into the final wheel disc shape. Alternatively, the blank may be formed by any suitable means, such as stamping and/or flow forming, into a wheel disc “preform” (not shown) having a particular partially formed wheel disc shape before it is formed into the final wheel disc shape.

The disc 12 includes a central hub mounting portion, indicated generally at 40, which defines the wheel axis X. The central hub mounting portion 40 includes a centrally located pilot aperture or hub hole 42. The hub hole 42 extends through and about the wheel axis X. The hub hole 42 may accommodate a portion of the axle and/or receive a protective/decorative cap (not shown). The hub hole 42 may have any suitable diameter. A plurality of lug bolt receiving holes 44 are formed in the central hub mounting portion 40 and are circumferentially spaced around the hub hole 42 and the wheel axis X. For example, the central hub mounting portion 40 may include five lug bolt receiving holes 42. Alternatively, the number and/or location of the lug bolt receiving holes 42 may be other than illustrated if so desired. The lug bolt receiving holes 42 receive the lug bolts (not shown) for securing the vehicle wheel 10 with lug nuts (not shown) on the axle of an associated vehicle.

The disc 12 may include a plurality of ventilation holes (not shown) formed therein. The vent holes may provide ventilation for wheel brakes (not shown) mounted adjacent to the wheel 10 and may also help in reducing the overall weight or mass of the wheel 10. The disc 12 can have any number of ventilation holes formed therein having any suitable shape. Alternatively or additionally, the disc 12 may be formed with a plurality of spokes (not shown) radially extending between the central hub mounting portion 40 and an outer circumferential edge of the disc 12.

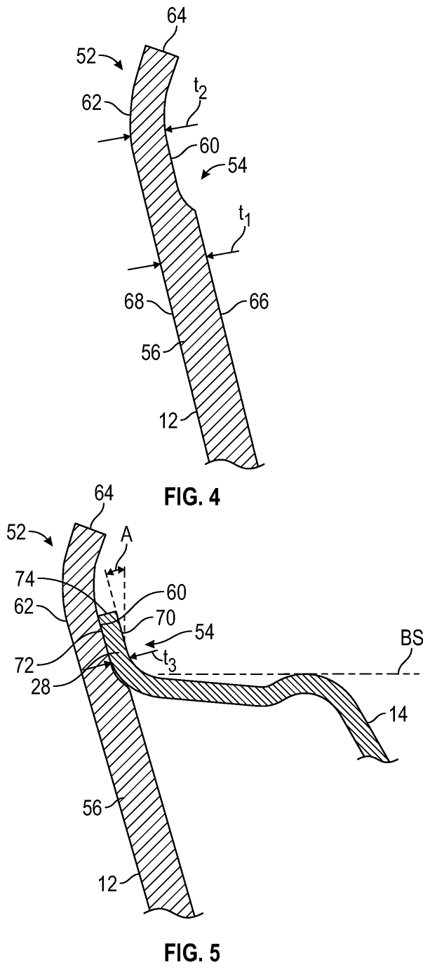

Referring now to FIG. 3, the outboard side 10a of the wheel 10 includes a circumferential wheel mounting portion, indicated generally at 50, where the disc 12 and the rim 14 are secured or joined together. In general, the wheel mounting portion 50 is formed by the joining of the outboard flange 28 of the rim 14 to an outer end, indicated generally at 52, of the disc 12. It is noted that FIGS. 4 through 7 illustrate the progressive steps of joining the rim 14 to the disc 12, and more specifically to the joining of the outboard flange 28 of the rim 14 to the outer end 52 of the disc 12, as will be discussed in detail below.

The structure of the outer end 52 of the disc 12 will now be discussed. Referring to FIGS. 3 and 4, the outer end 52 of the disc 12 generally includes a mounting area, indicated generally at 54. The mounting area 54 is located adjacent to but radially outwardly from a body portion 56 of the disc 12. The body portion 56 may have a conical or frustoconical shape about the wheel axis X, as shown in FIG. 2. The body portion 56 generally defines the main circular body portion of the disc 12 having the same thickness as most of the portions of the disc 12. For example, if the disc 12 were formed from a circular blank, the body portion 56 may have generally the same thickness as the thickness of the blank. Contrary, the mounting area 54 formed on the outer end 52 of the disc 12 defines a region of reduced thickness compared to the thickness of the body portion 56. As will be explained below, the reduced thickness of the mounting area 54 provides for a recess or mounting profile for properly locating and receiving the outboard flange 28 of the rim 14.

As shown in FIGS. 3 and 4, the outer end 52 of the disc 12 includes an inner surface 60, an outer surface 62, and an outermost tip 64. The mounting area 54 is preferably located on the inner surface 60. In the illustrated embodiment, the outer end 52 has a slight inward curve. The inner surface 60 may have any suitable shape or profile. Preferably, the profile shape of the inner surface 60 generally matches the shape of the mating outboard flange 28 of the disc 12 in which it engages with. The body portion 56 of the disc 12 defines an inner surface 66 and an outer surface 68.

As best shown in FIG. 4, the body portion 56 of the disc 12 has a thickness t₁ extending between the inner surface 66 and the outer surface 68. The mounting area 54 of the outer end 52 of the disc 12 has a thickness t₂ extending between the inner surface 60 and the outer surface 62. The thickness t₂ is less than the thickness t₁. In a preferred embodiment, the thickness t₁ is within the range of about 4 millimeters to about 8 millimeters. In a more preferred embodiment, the thickness t₁ is within the range of about 4.5 millimeters to about 7.5 millimeters. In a preferred embodiment, the thickness t₂ is within the range of about 2 millimeters to about 6 millimeters. In a more preferred embodiment, the thickness t₂ is within the range of about 3 millimeters to about 5 millimeters.

Referring now to FIGS. 3 and 5, the structure of the outboard flange 28 of the rim 14 will now be discussed. The outboard flange 28 is generally outwardly turned (in the direction from the inboard towards the outboard) and extends in a radially outwardly direction away from the wheel axis X. As shown in FIG. 4, the outboard flange 28 may be bent or curved at an angle A relative to the axis (or vertical as viewing FIG. 5). In a preferred embodiment, the angle A is within the range of about 0 degrees to about 45 degrees. In a more preferred embodiment, the angle A is about 20 degrees. Preferably, the angle A matches the approximate angle of the inner surface 60 of the mounting area 54 of the disc 12. The outboard flange 28 defines an inner surface 70, an outer surface 72, and an outermost tip 74. The outboard flange 28 has thickness t₃ extending between the inner surface 70 and the outer surface 72. In a preferred embodiment, the thickness t₃ is within the range of about 1.8 millimeters to about 5 millimeters. In a more preferred embodiment, the thickness t₃ is within the range of about 2 millimeters to about 4.5 millimeters.

As stated above, the mounting area 54 of the outer end 52 of the disc 12 can be observed or regarded as a recess for receiving the rim 14. Referring now to FIGS. 4 through 7 illustrating the steps in assembling the wheel 10, FIG. 4 shows the details of the profile of the mounting area 54 of the outer end 52 of the disc 12. As shown in FIG. 5, the rim 14 is then positioned adjacent the disc 12 such that the outer surface 72 of the outboard flange 28 of the rim 14 is placed against the inner surface 60 of the outer end 52 of the disc 12. Preferably, the shape and size of the inner surface 60 matches the shape and size of the outer surface 72, thereby providing a snug fit (no play or slop) when the disc 12 and the rim 14 are placed together, as shown in FIG. 5. This snug or tight fit helps in positioning and maintaining the disc 12 and the rim 14 together prior to the step of permanently joining or securing them together. After being properly positioned, such as shown in FIG. 5, the disc 12 and the rim 14 can then be secured or joined together by any suitable means. Suitable examples of securement include welding, adhesives, and mechanical fastening such as with the use of rivets, bolts, and screws.

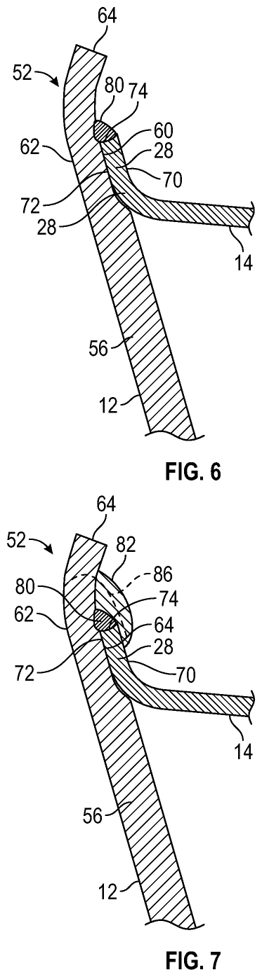

In a preferred embodiment, when the disc 12 and the rim 14 are formed from a metal, such as for example steel, the disc 12 and the rim 14 are welded together to form a permanent joining. Any suitable welding technique may be used. The welding may include a single weld or multiple welds. There is illustrated in FIGS. 6 and 7 an example of a suitable multiple welding technique or process for permanently joining the disc 12 and the rim 14. As shown in FIG. 6, a first weld 80 may be used to join the disc 12 and the rim 14 together. The first weld 80 is preferably a generally continuous circumferential bead extending along the outermost tip 74 of the outboard flange 28. As shown in FIG. 6, a portion of the first weld 80 may also blend into the inner surface 60 of the mounting area 54 of the outer end 52 of the outboard flange 28, thereby securing the disc 12 to the rim 14. It should be noted that the welding illustrations in the Figures are merely schematic and do not necessarily illustrate an exact weld in cross-section. It should also be understood that although the use of the first “weld” 80 is preferred, other securements (such as adhesives and mechanical fasteners) may be used instead of the first weld 80. After the first weld 80 is applied, a second weld 82, as shown in FIG. 7, may further be applied.

As shown in FIG. 7, the second weld 82 preferably is larger than the first weld 80. The second weld 82 may be positioned at any suitable position where the disc 12 mates with the rim 14. In a preferred embodiment, the larger second weld 82 is located over the first weld 80 completely covering the outermost tip 74 of the outboard flange 28. After the second weld 82 has been applied, it is preferred to “clean up” this circumferential wheel mounting portion 50 where the disc 12 and the rim 14 are secured together. Preferably, portions of the second weld 82 and the outer end 52 of the disc 12 are machined to remove material from the second weld 82 and the outer end 52 to provide a smooth curved circumferential edge of the wheel 10, thereby forming a full face fabricated euroflange type of wheel 10. The portions removed by a machining operation are indicated by broken lines 86 in FIG. 7. Any suitable machining or cutting operation may be used for the removal of the material to a desired profile shape. After this machining operation, the final profile of the circumferential wheel mounting portion 50 is provided, as illustrated in FIGS. 2 and 3.

It is noted that the first weld 80 may be utilized to obtain a precise weld having sufficient performance to effectively and securely join the disc 12 to the rim 14. The second weld 82 may be provided more for a “finish’ purpose to provide a relatively large amount of material which then can be machined to a desired shape and profile. If desired, the second “weld” 82 may be other than a “weld” and may simply be added “filler” material which may then be sufficiently machined or otherwise removed to provide a desired shape and profile. For example, the second weld 82 may be formed from polymers, ceramics, or any other suitable material.

Thus, in accordance with the present invention it can be realized or understood that the first weld 80 (or other suitable securement member, such as for example as described herein), is provided to join or secure the disc 12 and the rim 14 together. Whereas the second weld 82 (or other suitable securement member and/or filler material, such as for example described herein), is provided to either further assist in joining or securing the disc 12 and the rim 14 together or may be provided not for securement but to provide added material which may then be sufficiently machined or otherwise removed to provide the desired shape and profile of the outer end 52 of the wheel.

Referring to FIG. 3, portions of the second weld 82 and the outer end 52 of the disc 12 are machined to remove material from the second weld 82 and the outer end 52 to provide a smooth curved circumferential edge of the wheel 10, thereby forming a full face fabricated euroflange type of wheel 10. This euroflange type of wheel 10 may have any suitable size and shape of profile. For example, a curved inboard facing surface 90 formed in the second weld 82 may generally formed along a radius R. In a preferred embodiment, the radius R may be formed in accordance with the rim standards manuals TR&, ETRTO, JATMA and ALAPA applying the minimum radius according to specific rim profile flange. The outer edge of the full face fabricated euroflange type of wheel 10 may have a width W. In a preferred embodiment, the width W is within the range of about 8 millimeters to about 15 millimeters. In a more preferred embodiment, the width W is within the range of about 8.5 millimeters to about 14 millimeters. The outer edge of the full face fabricated euroflange type of wheel 10 may have a height H extending radially outwardly from the beadseat diameter BS. In a preferred embodiment, the height H may be formed in accordance with the rim standards manuals TR&, ETRTO, JATMA and ALAPA applying the minimum height according to specific rim profile flange.

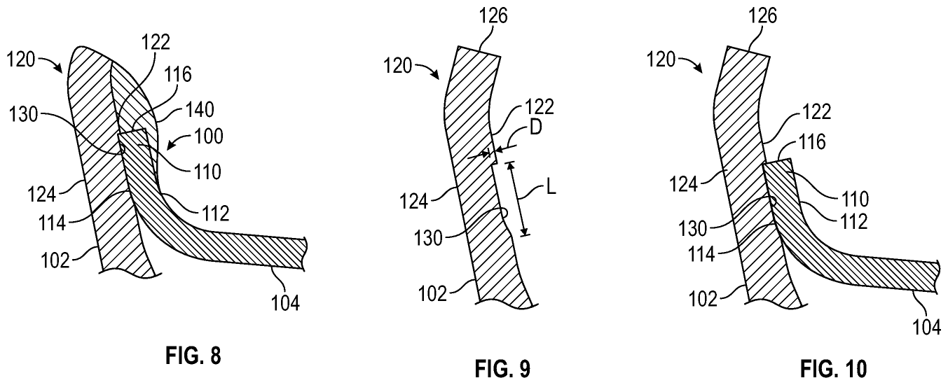

There is illustrated in FIG. 8 a second embodiment of an outboard mounting portion, indicated generally at 100, of a full face fabricated euroflange type of wheel, wherein portions of a disc 102 and a rim 104 are joined together. The outboard mounting portion 100 is similar in structure and function to the mounting portion 50 of the wheel 10. It is noted that FIGS. 4 through 7 illustrate the progressive steps of joining the rim 104 to the disc 102.

The rim 104 includes an outboard flange 110 having an inner surface 112, and outer surface 114, and an outermost tip 116. The outboard flange 110 is similar to structure and function as the outboard flange 28 of the wheel 10. The disc 102 includes an outer end, indicated generally at 120. The outer end 120 includes an inner surface 122, and outer surface 124, and an outermost tip 126. As best shown in FIG. 9, a narrow circumferential recess 130 is formed in the inner surface 122. Preferably, the recess 130 is relatively narrow having a depth D. In a preferred embodiment, the depth D is within the range of about 0.1 millimeters to about 2 millimeters. In a more preferred embodiment, the depth D is within the range of about 0.4 millimeters to about 1.2 millimeters. The recess 114 has a radial length L. The radial length L is preferably sized to accommodate the outboard flange 110 of the rim 104 received in the recess 130 is a snug manner, as shown in FIG. 10. In a preferred embodiment, the radial length L is within the range of about 2 millimeters to about 10 millimeters. In a more preferred embodiment, the radial length L is within the range of about 4 millimeters to about 8 millimeters.

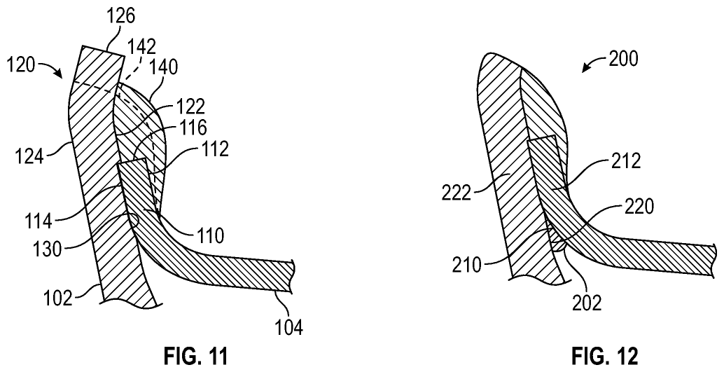

The recess 130 may be formed by any suitable manner. For example, the recess 130 may be formed by a machining or cutting process to remove material at the outer end 120 of the disc 102. Alternatively, the recess 130 may be formed by a stamping or rolling process. To join the disc 102 and the rim 104, the outboard flange 110 of the rim 104 is positioned within the recess 130, as shown in FIG. 10. More specifically, the outer surface 114 of the outboard flange 110 is positioned against and inside the recess 130. Once positioned, a welding operation may be performed to apply a weld 140 to the outboard flange 110 of the rim 104 and the outer end 120 of the disc 102, as shown in FIG. 11. A single weld 140 may be used instead of the dual welds used for the wheel 10.

After the weld 140 has been applied, portions of the weld 140 and the outer end 120 of the disc 102 may be machined to remove material from the weld 140 and the outer end 120 to provide a smooth curved circumferential edge, thereby forming a full face fabricated euroflange type of wheel. The portions removed by a machining operation are indicated by broken lines 142 in FIG. 11.

There is illustrated in FIG. 12 a third embodiment of an outboard mounting portion, indicated generally at 200, of a full face fabricated euroflange type of wheel. The mounting portion 200 is similar to the mounting portion 100. One of the differences is that the mounting portion 200 includes a second weld 202 formed between an outer surface 210 of an outboard flange 212 and the inner surface 220 of an outer end 222. The second weld 202 may be included to provide for added strength.

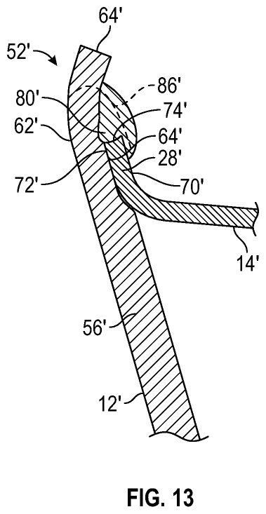

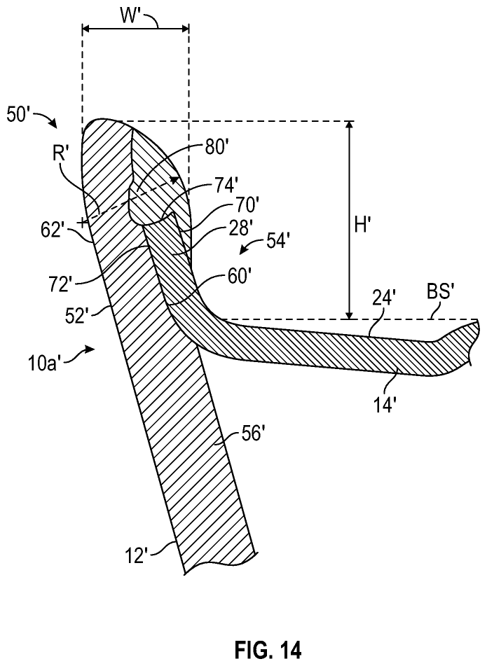

There is illustrated in FIG. 13 a fourth embodiment of an outboard mounting portion, indicated generally at 50′, of a full face fabricated euroflange type of wheel. The mounting portion 50′ is similar to the mounting portion 50. Note that like or similar structures in FIGS. 13 and 14 are labeled with a like reference number including a prime (′) superscript relative to the reference numbers with respect to the mounting portion 50 and/or wheel 10a as shown in the FIGS. 3 through 7. One of the differences is that the mounting portion 50′ utilizes a single weld 80′ instead of two separate welds like the welds 80 and 82 of the mounting portion 50. In the case of the single weld 80′, the weld 80′ may provide the function of providing both the securement of the rim 14′ to the disc 12′, as well as providing a sufficient amount of material that can later be machined off to provide the desired shape and profile of a euroflange type shape. As shown, FIG. 14 illustrates the application of the single weld 80′ prior to the machining operation. The machined final profile shape is indicted by phantom lines 86′ in FIG. 14.

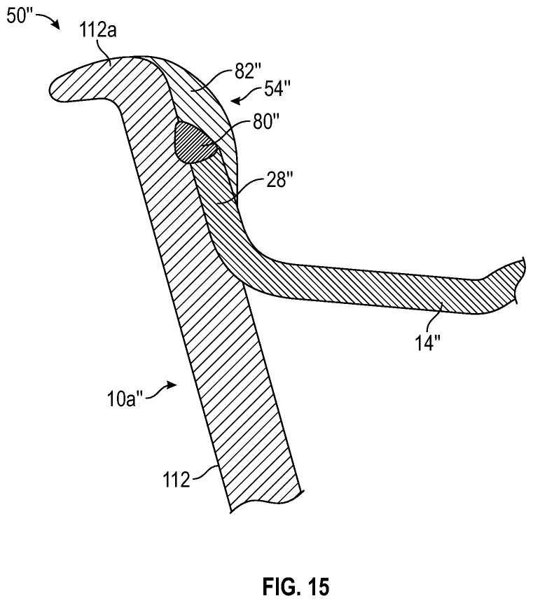

There is illustrated in FIG. 15 a fifth embodiment of an outboard mounting portion, indicated generally at 50″, of a full face fabricated non-euroflange type of wheel, indicated generally at 10a″. The mounting portion 50″ is similar to the mounting portion 50. Note that like or similar structures in FIG. 15 are labeled with a like reference number including a double prime (″) superscript relative to the reference numbers with respect to the mounting portion 50 and/or wheel 10a as shown in the FIGS. 3 through 7. One of the differences is that full face fabricated non-euroflange type of wheel 10a″ includes a wheel disc 112 which has an outboard tire bead seat retaining flange having a generally axially outwardly extending lip or portion 112a capable of receiving a conventional wheel balance weight.

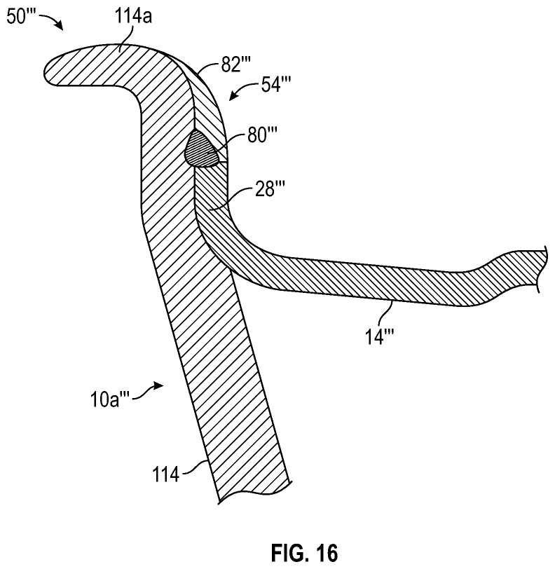

There is illustrated in FIG. 16 a sixth embodiment of an outboard mounting portion, indicated generally at 50′″, of a full face fabricated non-euroflange type of wheel, indicated generally at 10a′″. The mounting portion 50′″ is similar to the mounting portion 50. Note that like or similar structures in FIG. 16 are labeled with a like reference number including a triple prime (′″) superscript relative to the reference numbers with respect to the mounting portion 50 and/or wheel 10a as shown in the FIGS. 3 through 7. One of the differences is that full face fabricated non-euroflange type of wheel 10a″ includes a wheel disc 114 which has an outboard tire bead seat retaining flange having a generally axially outwardly extending lip or portion 114a capable of receiving a conventional wheel balance weight. Also, the wheel rim 14′″ includes an outboard flange 28′″ which is at a different angle or orientation compared to the outboard flange 28 of the wheel rim 14.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A full face fabricated vehicle wheel comprising:
a rim defining a central axis of the wheel, wherein the rim includes:
an inboard retaining flange;
an inboard tire bead seat;
an outboard tire bead seat;
a well located between the inboard and outboard tire bead seats;
an outboard flange, wherein the outboard flange is outwardly turned and extends in a radially outwardly direction away from the central axis; and
a disc having:
a central hub mounting portion including a hub hole located about the central axis and a plurality of lug bolt receiving holes circumferentially spaced about the hub hole; and
a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto;
wherein the full face fabricated vehicle wheel is one of a euroflange vehicle wheel or a non-euroflange vehicle wheel.

2. The wheel of claim 1, wherein the rim is secured to the disc by one of welding, adhesives, and mechanical fasteners.

3. The wheel of claim 1, wherein the outer end of the disc defines an inner surface, an outer surface, and an outermost tip, and wherein the outboard flange of the rim is configured to be secured onto the inner surface.

4. The wheel of claim 3, wherein the outboard flange of the rim defines an inner surface, an outer surface, and an outermost tip, and wherein the outer surface of the outboard flange engages with and is secured onto the inner surface of the outer end of the disc.

5. The wheel of claim 4, wherein the outboard flange of the rim is secured to the mounting area of the disc by a first weld located at the outermost tip of the outboard flange of the rim, and wherein the first weld is a generally continuous circumferential bead extending along the outermost tip of the outboard flange.

6. The wheel of claim 5, wherein the rim includes a second weld located over the first weld completely covering the outermost tip of the outboard flange.

7. The wheel of claim 6, wherein the second weld and the outer end of the disc are machined to remove material from the second weld and the outer end of the disc to provide a smooth curved circumferential edge of the wheel.

8. The wheel of claim 1 further including a securement securing the outboard flange of the rim to the mounting area of the disc, wherein a material is added and located over the securement, and wherein the outer end of the disc is machined to remove portions of the added material and the outer end of the disc to provide a smooth curved circumferential edge of the wheel.

9. The wheel of claim 1 further including a single weld that secures the outboard flange of the rim to the mounting area of the disc, and wherein the single weld provides enough material such that the outer end of the disc and the single weld may be machined to provide a smooth curved circumferential edge of the wheel.

10. A full face fabricated vehicle wheel comprising:
a rim having an outwardly turned outboard flange extending generally radially outwardly and extending in a direction away from a central axis of the vehicle wheel; and
a disc having a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto;
wherein the full face fabricated vehicle wheel is one of a euroflange vehicle wheel or a non-euroflange vehicle wheel.

11. The wheel of claim 10, wherein the rim is secured to the disc by one of welding, adhesives, and mechanical fasteners.

12. The wheel of claim 10, wherein the outer end of the disc defines an inner surface, an outer surface, and an outermost tip, and wherein the outboard flange of the rim is configured to be secured onto the inner surface.

13. The wheel of claim 12, wherein the outboard flange of the rim defines an inner surface, an outer surface, and an outermost tip, and wherein the outer surface of the outboard flange engages with and is secured onto the inner surface of the outer end of the disc.

14. The wheel of claim 13, wherein the outboard flange of the rim is secured to the mounting area of the disc by a first weld located at the outermost tip of the outboard flange of the rim, and wherein the first weld is a generally continuous circumferential bead extending along the outermost tip of the outboard flange.

15. The wheel of claim 13, wherein the rim includes a second weld located over the first weld completely covering the outermost tip of the outboard flange.

16. The wheel of claim 15, wherein the second weld and the outer end of the disc are machined to remove material from the second weld and the outer end of the disc to provide a smooth curved circumferential edge of the wheel.

17. A vehicle wheel comprising:
a rim defining an axis and having an outboard flange: and
a disc having a recess formed therein at an outer end such that the recess defines a region of reduced thickness at the outer end, wherein the outboard flange of the rim is at least partially disposed within the recess of the disc, and wherein the rim is configured to be secured to the disc wherein the full face fabricated vehicle wheel is one of a euroflange vehicle wheel or a non-euroflange vehicle wheel.

18. The wheel of claim 17, wherein the recess is formed in the disc by a machining process to remove material of the outer end of the disc.

19. The wheel of claim 17, wherein the recess is formed in the disc by one of a stamping and rolling process.

20. The wheel of claim 17, wherein the rim is secured to the disc by one of welding, adhesives, and mechanical fasteners.

21. The wheel of claim 17, wherein the rim is secured to the disc by a weld located at an outermost tip of the outboard flange.

22. The wheel of claim 21, wherein the weld is a generally continuous circumferential bead extending along the outermost tip of the outboard flange.

23. A method for producing a full face fabricated vehicle wheel comprising the steps of:
providing a rim defining a central axis of the wheel, wherein the rim includes: an inboard retaining flange; an inboard tire bead seat; an outboard tire bead seat; a well located between the inboard and outboard tire bead seats; an outboard flange, wherein the outboard flange is outwardly turned and extends in a radially outwardly direction away from the central axis;
providing a disc having: a central hub mounting portion including a hub hole located about the central axis and a plurality of lug bolt receiving holes circumferentially spaced about the hub hole; and a mounting area formed at an outer end of the disc, the mounting area defining a region of reduced thickness at the outer end relative to a thickness of the disc directly adjacent to the outer end, wherein the outboard flange of the rim is configured to be disposed within the mounting area of the disc and secured thereto; and
securing the disc to the rim; wherein the full face fabricated vehicle wheel is one of a euroflange vehicle wheel or a non-euroflange vehicle wheel.

24. The method of claim 23 wherein the disc is secured to the rim by at least one weld.

25. The method of claim 23 wherein the disc is secured to the rim by a first weld and then by a second weld located over the first weld completely covering an outermost tip of the outboard flange.
